(19) United States
(12) Patent Application Publication
(10) Pub. No.: US 2024/0296103 A1
(43) Pub. Date: Sep. 5, 2024

(54) CUSTOMIZED AUDIT TEMPLATES

(71) Applicant: Rakuten Mobile, Inc., Tokyo (JP)

(72) Inventors: Rahul GUPTA, Indore (IN); Aaditya DHARAMPURIKAR, Indore (IN); Akash GUPTA, Indore (IN); Divya KOTHARI, Indore (IN)

(21) Appl. No.: 17/999,854

(22) PCT Filed: Sep. 22, 2022
(86) PCT No.: PCT/US2022/044364

§ 371 Date: Nov. 24, 2022

(51) Int. Cl. G06F 11/30; G06F 40/186; H04L 43/06

(52) U.S. Cl. CPC G06F 11/3006; G06F 40/186; H04L 43/06

(57) ABSTRACT

Customizable audit templates are provided for auditing a network. A list of custom audit templates are displayed on an audit template user interface (UI) presented on a display device. From the audit template UI, an action is selected from: using a pre-existing audit template selected from the list of custom audit templates, editing the pre-existing audit template selected from the list of custom audit templates, or creating a new audit template to present in the list of custom audit templates. Based on the selection, one audit template is identified from the list of custom audit templates to use to perform an audit. An audit is executed based on the one audit template identified from the list of custom audit templates. A report is generated using results obtained from executing the audit based on the one audit template identified from the list of custom audit templates.

### TECHNICAL FIELD

This description relates to a system, method, and non-transitory computer-readable media for providing customized audit templates.

### BACKGROUND

Wireless networks support a large numbers of wireless subscribers running one or more applications, wherein traffic, is packetized and transported via IP networks according to multiple network elements that use different transport technologies and applied quality-of-service (QOS) policies. Such networks are inherently complex and present new challenges to network service providers and to the network management tools network service providers rely upon to ensure consistent delivery of high-quality services to their mobile subscribers.

Existing network management systems used within the context of, illustratively, network operations centers (NOCs) or Network Management Systems (NMS) provide a visualization of a deployed network. Users select a network element to expand the network element into at least some of its constituent sub-elements to identify specific components.

Existing network management systems require significant human knowledge of the network topology and likely sources of failure or operational degradation. There are a large number of parameters in the network, including different equipment types, domains, technology, etc. In response to changes or failures occurring in the system, the user downloads data or fetches the data. The data is presented in a spreadsheet for comparison to benchmarks and for further analysis.

Currently obtaining this data is performed manually and the process involves a very complex effort. Existing audit solutions provide for manually auditing of particular parameters or a specific set of parameters, or in the case of automation, auditing is performed on specific types of parameters, e.g. a set of golden parameters. Audits are performed for fixed values of parameters, for a fixed time, or fixed network element. Once data is collected, the user filters out information from that information. Filtering data is tedious and prone to error due the volume of data that is involved. There is no customizable automated auditing available to a user.

### SUMMARY

In at least embodiment, a method for providing customized audit templates includes displaying a list of custom audit templates on an audit template user interface (UI) presented on a display device, from the audit template UI, receiving a selection to perform an action selected from: using a pre-existing audit template selected from the list of custom audit templates, editing the pre-existing audit template selected from the list of custom audit templates, or creating a new audit template to present in the list of custom audit templates, based on the selection, identifying one audit template from the list of custom audit templates to use to perform the audit on at least one network element, executing the audit to collect performance data of the at least one network element based on the one audit template identified from the list of custom audit templates, and generating a report using results obtained from executing the audit based on the one audit template identified from the list of custom audit templates.

In at least embodiment, a device for providing customized audit templates includes a memory storing computer-readable instructions, and a processor connected to the memory, wherein the processor is configured to execute the computer-readable instructions to display a list of custom audit templates on an audit template user interface (UI) presented on a display device, from the audit template UI, receive a selection to perform an action selected from: using a pre-existing audit template selected from the list of custom audit templates, editing the pre-existing audit template selected from the list of custom audit templates, or creating a new audit template to present in the list of custom audit templates, based on the selection, identifying one audit template from the list of custom audit templates to use to perform the audit on at least one network element, executing the audit to collect performance data of the at least one network element based on the one audit template identified from the list of custom audit templates, and generating a report using results obtained from executing the audit based on the one audit template identified from the list of custom audit templates.

In at least embodiment, a non-transitory computer-readable media having computer-readable instructions stored thereon, which when executed by a processor causes the processor to perform operations including displaying a list of custom audit templates on an audit template user interface (UI) presented on a display device, from the audit template UI, receiving a selection to perform an action selected from: using a pre-existing audit template selected from the list of custom audit templates, editing the pre-existing audit template selected from the list of custom audit templates, or creating a new audit template to present in the list of custom audit templates, based on the selection, identifying one audit template from the list of custom audit templates to use to perform the audit of at least one network element, executing the audit to collect performance data of the at least one network element based on the one audit template identified from the list of custom audit templates, and generating a report using results obtained from executing the audit based on the one audit template identified from the list of custom audit templates.

### BRIEF DESCRIPTION OF THE DRAWINGS

Aspects of the present disclosure are best understood from the following detailed description when read with the accompanying figures. It is noted that, in accordance with the practice in the industry, various features are not drawn to scale. In fact, the dimensions of the various features are able to be increased or reduced for clarity of discussion.

FIG. 1 illustrates a mobile network according to at least one embodiment.

FIG. 2 illustrates an Audit Template Landing Page according to at least one embodiment.

FIG. 3 shows a Basic Detail Entry Page according to at least one embodiment.

FIG. 4 illustrates a Select Parameter Page according to at least one embodiment.

FIG. 5 illustrates a Set Parameter Value Page according to at least one embodiment.

FIG. 6 illustrates a Preview Page according to at least one embodiment.

FIG. 7 illustrates the Audit Template Landing Page according to at least one embodiment.

FIG. 8 illustrates options available from Audit Template Landing Page according to at least one embodiment.

FIG. 9 illustrates a Select Network Element (NE) page according to at least one embodiment.

FIG. 10 illustrates a Scheduling Window according to at least one embodiment.

FIG. 11 is a flowchart of a method for providing customized audit templates according to at least one embodiment.

FIG. 12 illustrates an example of an audit report based on a customized audit template according to at least one embodiment.

FIG. 13 is a high-level functional block diagram of a processor-based system according to at least one embodiment.

### DETAILED DESCRIPTION

Embodiments described herein describes examples for implementing different features of the provided subject matter. Examples of components, values, operations, materials, arrangements, or the like, are described below to simplify the present disclosure. These are, of course, examples and are not intended to be limiting. Other components, values, operations, materials, arrangements, or the like, are contemplated. For example, the formation of a first feature over or on a second feature in the description that follows include embodiments in which the first and second features are formed in direct contact and include embodiments in which additional features are formed between the first and second features, such that the first and second features are unable to make direct contact. In addition, the present disclosure repeats reference numerals and/or letters in the various examples. This repetition is for the purpose of simplicity and clarity and does not in dictate a relationship between the various embodiments and/or configurations discussed.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of the device in use or operation in addition to the orientation depicted in the FIGS. The apparatus is otherwise oriented (rotated 90 degrees or at other orientations) and the spatially relative descriptors used herein likewise are interpreted accordingly.

Terms “system” and “network” in embodiments of this application are used interchangeably. “At least one” means one or more, and “a plurality of” means two or more. The term “and/or” describes an association relationship between associated objects and indicates that three relationships exist. For example, A and/or B indicate the following cases: Only A exists, both A and B exist, and only B exists, where A and B is singular or plural. The character “/” generally indicates an “or” relationship between the associated objects. “At least one of” or a similar expression thereof means any combination of items, including any combination of singular items (pieces) or plural items (pieces). For example, “at least one of A, B, and C” includes A, B, C, AB, AC, BC, or ABC, and ““at least one of A, B, or C” includes A, B, C, A and B, A and C, B and C, or A and B and C.

Terms like “user equipment,” “mobile station,” “mobile,” “mobile device,” “subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming data-stream or signaling-stream. The foregoing terms are utilized interchangeably in the subject specification and related drawings. The terms “access point,” “base station,” “Node B,” “evolved Node B (eNode B),” next generation Node B (gNB), enhanced gNB (en-gNB), home Node B (HNB),” “home access point (HAP),” or the like refer to a wireless network component or apparatus that serves and receives data, control, voice, video, sound, gaming data-stream or signaling-stream. from UE.

Embodiments described herein describes examples for implementing different features of the provided subject matter. Examples of components, values, operations, materials, arrangements, or the like, are described below to simplify the present disclosure. These are, of course, examples and are not intended to be limiting. Other components, values, operations, materials, arrangements, or the like, are contemplated. For example, the formation of a first feature over or on a second feature in the description that follows include embodiments in which the first and second features are formed in direct contact and include embodiments in which additional features are formed between the first and second features, such that the first and second features are unable to make direct contact. In addition, the present disclosure repeats reference numerals and/or letters in the various examples. This repetition is for the purpose of simplicity and clarity and does not in dictate a relationship between the various embodiments and/or configurations discussed.

In at least one embodiment, customizable audit templates are created to audit the parameters of network elements. The user is able to select a pre-existing temple, edit a pre-existing audit template, or create a new audit template for auditing particular equipment where the data is populated into a report. By using customizable audit templates, a user is provided more flexibility and control over what data to collect. In at least one embodiment, a user selects network elements to audit, and select parameters of interest. In response to a user wanting to audit, for example, core elements, the user creates a template that is customized for auditing the data the user is interested in reviewing. Audit templates are created or edited to audit the parameters the user is interested in reviewing.

Advantages include being able to perform an audit using an audit template that is created by the user for auditing parameters of interest to the user and based on user selection. The time of the audit is selectable as well as the network element. Audit templates are created for a customized list of parameters, e.g., individual parameters, a set of parameters, or all parameters. The customized audit templates enable audits for a single network element or multiple network elements. Currently, this type of customization is not available.

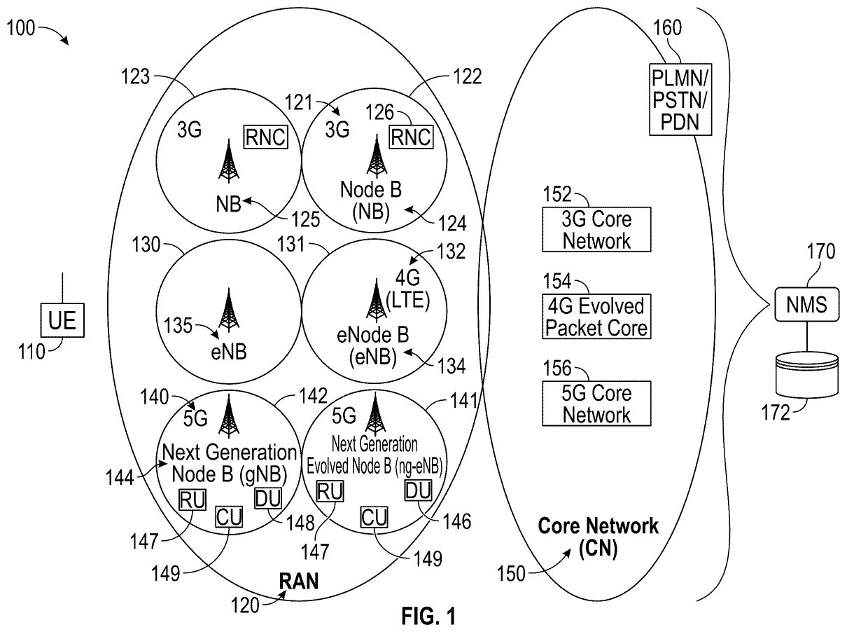

FIG. 1 illustrates a mobile network 100 according to at least one embodiment.

In FIG. 1, a mobile telecommunication network couples User Equipment (EU) 110 through Radio Access Network (RAN) 120 to a Core Network (CN) 150. RAN 120 connects individual devices, such as User Equipment (EU) 110 to other parts of a network, e.g., CN 150, through radio connections. RAN 120 is responsible for managing radio resources, including strategies and algorithms for controlling power, channel allocation and data rate.

RANs 120 have evolved over time, from 3G to 5G. For example, RANs 120 are implemented in various configurations, such as Global System for Mobile Communications (GSM) RAN (GRAN), GSM Enhanced Data Rates for GSM Evolution (EDGE) RAN (GERAN), Universal Mobile Telecommunications Service (UMTS) Terrestrial RAN (UTRAN), Evolved UMTS Terrestrial RAN (E-UTRAN), Centralized/Cloud RAN (CRAN), Virtualized RAN (VRAN), and Open RAN (ORAN).

In a 3G network 121, RAN 120 includes the base station for Cells Sites 122, 123, which is called a Node B (NB) 124, 125, and a Radio Network Controller (RNC) 126. RNC 126 controls and manages the radio transceivers in Node Bs 124, 125, as well as manages operational functions, such as handoffs, and the radio channels. The RNC 126 handles communication with the 3G Core Network 152.

In a 4G network 132, Cell Sites 130, 131 are implemented using Evolved Node Bs (eNodeBs or eNBs) 134, 135 for the radio base station. The eNodeBs 134, 135 are able to perform the radio access functions that are equivalent to the combined work that Node Bs 124, 125 and RNC do in 3G and connect to the Evolved Packet Core 154.

In a 5G network 140, Cell Sites 141, 142 are implemented using one of two types of RANs: Next Generation Node B (gNodeB) 144 and Next Generation Evolved Node B (ng-eNB) 146. The ng-eNB 146 is an enhanced version of 4G eNodeB and connects 5G UE 110 to the 5G Core Network (5GC) 156 using 4G LTE air interface. The gNB 144 allows 5G UE 110 to connect with a 5GC 156 using 5G NR air interface. The gNBs 144 and ng-eNBs 146 are interconnected by means of the Xn interface. The gNBs 144 and ng-eNBs 146 are also connected by means of the NG interfaces to the 5GC 156.

In 5G, for example, an Open RAN environment is able to be implemented wherein the RAN 120, provided by The gNBs 144 and ng-eNBs 146, is separated into the Radio Unit (RU) 147, the Distributed Unit (DU) 148, and the Centralized Unit (CU) 149. The RU 147 is where the radio frequency signals are transmitted, received, amplified, and digitized. The RU 147 is located near or integrated into, the antenna. The DU 148 and CU 149 are the computation parts of the base station, sending the digitalized radio signal into the network. The DU 148 is physically located at or near the RU 147 whereas the CU 149 is often located nearer the Core Network 150. The different interfaces associated with the Open RAN 120 include the Fronthaul (FH) that lies between the RU 147 and the DU 148, the Midhaul (MH) that lies between the DU 148 and the CU 149, and the Backhaul (BH) that lies between the CU 149 and the Core Network 150.

Core Network (CN) 150 connects RAN 120 to networks 160, such as a Public Landline Mobile Network (PLMN), a Public Switched Telephone Network (PSTN) and a Packet Data Network (PDN). CN 150 provides high-level traffic aggregation, routing, call control/switching, user authentication and charging. The 3G CN 152 involves two different domains: circuit switched elements and packet switched elements. The 4G Evolved Packet Core (EPC) 154 includes four main network elements: the Serving Gateway (S-GW), the packet data network (PDN) Gateway (P-GW), the mobility management entity (MME), and the Home Subscriber Server (HSS). The S-GW routes and forwards data packets from the UE and acts as the mobility anchor during inter-eNodeB handovers. The P-GW acts as an ingress and egress point to the EPC from a PDN (Packet Data Network) such as the Internet. The MME manages UE access network and mobility, as well as establishing the bearer path for User Equipment (UE). The MME is also concerned with the bearer activation/deactivation process. The HSS is the master database for a given subscriber, acting as a central repository of information for network nodes. Subscriber related information held by the HSS includes user identification, security, location, and subscription profile. The EPC is connected to the external networks, which includes the IP Multimedia Core Network Subsystem (IMS). 5GC 156 supports new network functions (NFs) associated with the packet core and user data management domains. 5GC 156 provides a decomposed network architecture with the introduction of a service-based interface (SBI), and control plane and user plane separation (CUPS). 5GC decomposes the 4G MME into an Access and Mobility Management Function (AMF) and a Session Management Function (SMF). The AMF receives connection and session related information from the UE, but is responsible for handling connection and mobility management tasks. Messages related to session management are forwarded to the SMF.

The network is managed by the network management system (NMS) 170, which provides several network management functionalities. According to at least one embodiment, the NMS monitors network elements in the mobile network 100 and logs data regarding the performance of the network elements. Collecting the performance information by the NMS 170 is critical because failing to collect the information associated with, for example, the RAN 120 or CN 150 presents timely and effective management of the mobile network 100. A lack of sufficient and timely data affects a network operator's ability to troubleshoot and manage the mobile network 100. In at least one embodiment, NMS 170 enables a user to create customizable audit templates to audit the parameters of network elements. The user is able to select a pre-existing temple, edit a pre-existing audit template, or create a new audit template for auditing particular equipment and parameters of network elements. NMS 170 performs the audit according to a scheduled time to collect the performance data of network elements. The data obtained by executing an audit template is populated into a report, where the user is able to download the report to determine an action to take to address any issues found in the report. By using customizable audit templates, a user is provided more flexibility and control over what data to collect.

A user is able to access the NMS 170 through a Configuration Manager (CM) User Interface (UI). Through the CM UI the user is able to access an inventory database 172 that maintains various templates, including audit templates. From the inventory database 172, the user is able to select a pre-existing temple, edit a pre-existing audit template, or alternatively, the user is able to use the CM UI to create a new audit template for auditing particular equipment and parameters of network elements. Data associated with the network elements and parameters of the network elements are logged and stored in inventory database 172. Those skilled in the art understand that inventory database 172 in one embodiment is a distributed database system. In at least one other embodiment, the inventory database 172 is maintained in a central database resident on one or more servers located at or near the NMS 170.

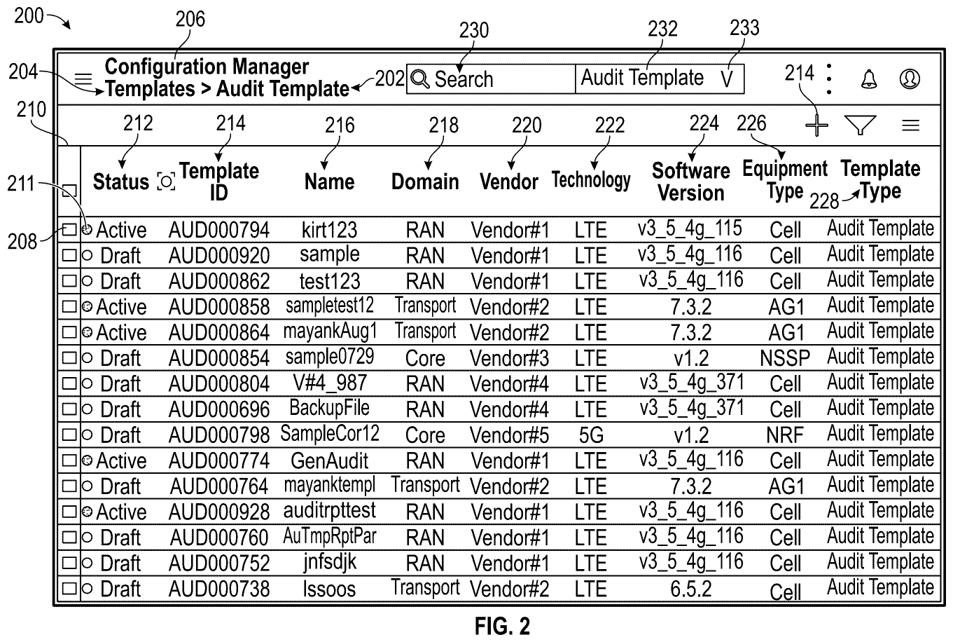

FIG. 2 illustrates an Audit Template Landing Page 200 according to at least one embodiment.

In FIG. 2, Audit Template Landing Page 200 is displayed in response to the user accessing the audit template system. In the manual method currently existing, the user filters out multiple details, such as the basic details, the network equipment, domain, vendor, technology, site type, etc. Audit Template Landing Page 200 is shown as being under the Audit Template system 202, which is a subset of Templates 204. The Audit Template Landing Page 200 is presented from the Configuration Manager UI 206.

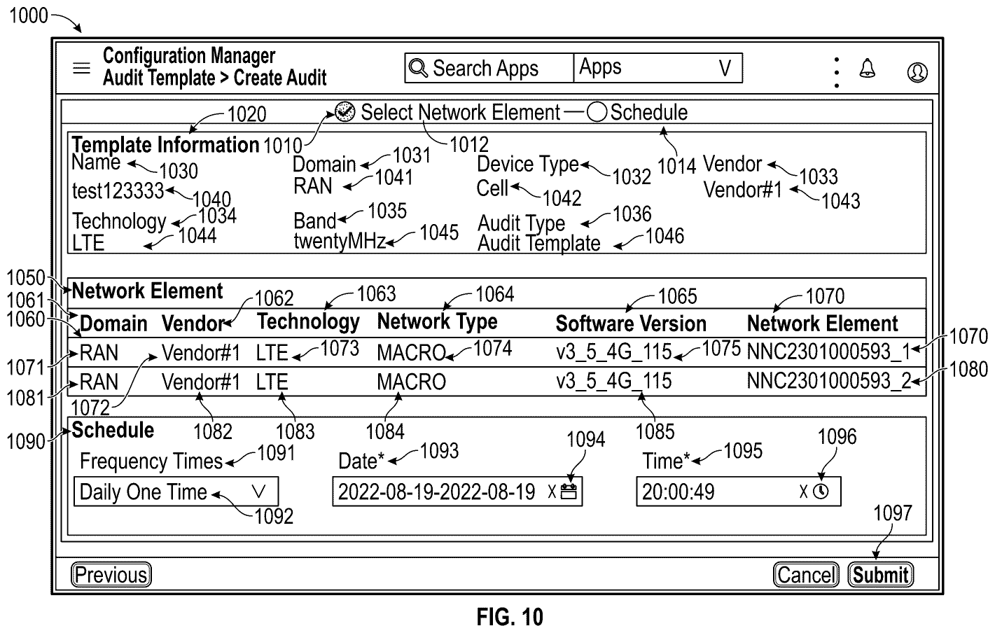

Audit Template Landing Page 200 displays a List Of Custom Audit Templates 210. Through use of the Audit Template Landing Page 200, the user is able to select a pre-existing audit template 211 from the List of Custom Audit Templates 210, edit a selected pre-existing audit template 211 by clicking in the Check Box 208 (and selecting an Edit Icon 1041 as described in FIG. 10 below), or create a new audit template by selecting the “add/+” icon 214.

The Listing Of Audit Templates 210 presents Audit Template Status 212, Template ID 214, Template Name 216, Domain 218, Vendor Name 220, Technology associated with the Audit Template 222, Software Version 224, Equipment Type 226 and Template Type 228. A Search Window 230 is provided for the user to perform a search for an Audit Template 232. A drop-down menu 233 enables the user to select what type of template the user is searching for in the Search Window 230. FIG. 2 illustrates that Audit Template 232 has been selected in the drop-down menu 233.

To create an audit template from the Audit Template Landing Page 200, the user selects the “add/+” icon 214. The audit template system is able to automatically sort through parameters associated with the Template ID 214 and Template Name 216, including parameters associated with Domain 218, Vendor Name 220, Technology 222 and save the collected data for reuse or as a basis for a new template based on edits.

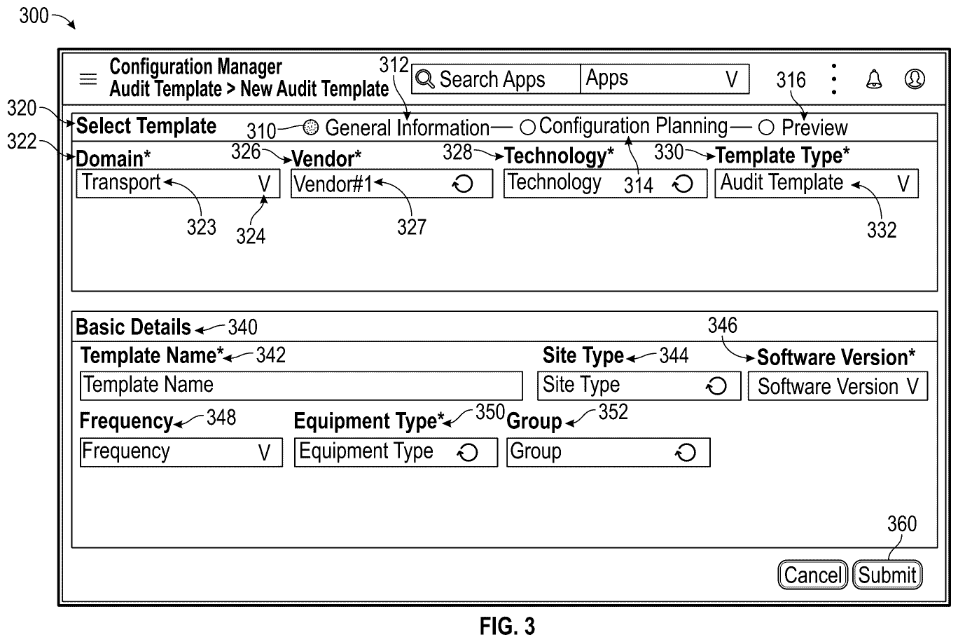

FIG. 3 shows a Basic Detail Entry Page 300 according to at least one embodiment.

In FIG. 3, the Basic Detail Entry Page 300 is displayed in response to selecting the “add/+” icon 214 in FIG. 2. The user is guided by the Basic Data Entry Page 300 to input specific information. Thus, the user does not manually enter data. The user is given the visibility to select input via the windows, which in some cases provide drop-down menus for entering information.

A Stage Notification 310 is presented illustrating that the Basic Detail Entry Page 300 is at a stage for entering General Information 312. As shown in the Stage Notification 310, a Configuration Planning stage 314 and Preview stage 316 follow in sequence after the stage entering General Information 312.

A Select Template Area 320 is shown under the Stage Notification 310. Select Template Area 320 includes a Domain Window 322 where Transport 323 has been selected. Transport 323 is one type of domain the user is able to select from Drop-Down Menu 324. Other choices include RAN (Radio Access Network) and Core (i.e., Core Network). RAN provides radio access technology to assist in coordinating network resources across wireless devices and provides the connection between a Core Network and devices, such as a mobile phones, computers, or any remotely controlled machine. Examples of types of RANs include GRAN (GSM radio access networks), GERAN (GSM EDGE Radio Access networks), UTRAN (Universal Mobile Telecommunications Service (UMTS) radio access networks), E-UTRAN (Evolved UTRAN radio access networks), CRAN (Cloud-radio access networks), VRAN (Virtualized-radio access networks), and ORAN (Open-radio access networks). The Core Network is a mobile exchange and data network that manages mobile voice, data, and internet connections.

Vendor Window 326 is for entry of the name of the Vendor#1 327. Technology Window 328 is used to define the type of technology associated with the audit template. For example, a user is able to enter terms such as LTE (Long Term Evolution) and 5G in Technology Window 328. LTE is a fourth generation (4G) wireless standard. 5G is the fifth-generation technology standard for broadband cellular networks and the planned successor to 4G networks. A Template Type Window 330 is used to define the type of template being created. Here, an Audit Template 332 is selected.

A Basic Details Area 340 is used to enter basic information about the audit template being created. Basic Details Area 340 includes a Template Name Window 342 for naming the audit template being created. For example, test123333 is a name that is able to be given to a new audit template. A Site Type Window 344 is used to identify the type of cell, e.g., macro cell, micro cell, femto cell, etc. A Software Version Window 346 is used to identify the version of the software, e.g., v3_5_4g_115. A Frequency Window 348 is used to identify the channel bandwidth, e.g., 20 MHz, 40 MHZ, etc. An Equipment Type Window 350 is used to identify the type of equipment associated with the audit template, such as Cell, Aggregate Router (AG), NSSP (Network Slice Selection Policy), NRF (Network Repository Function). Network slicing involves the creation of multiple unique logical and virtualized networks over a common multi-domain infrastructure. A mobile operator is able to split its physical network resources into multiple logical slices and lease these slices out to interested parties. NSSP provides a set of rules governing how the network resources are divided. A Group Window 352 is used to identify a test group, e.g., test21e2i. After the user has completed entry of the data in Basic Detail Entry Page 300, the user selects the Submit button 360 to begin entering parameter data.

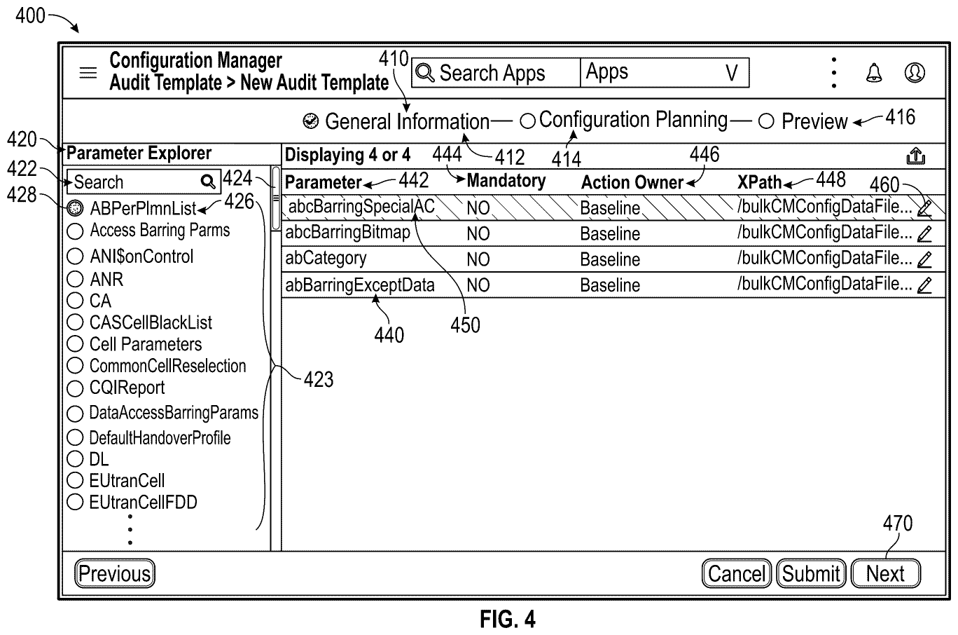

FIG. 4 illustrates a Select Parameter Page 400 according to at least one embodiment.

In FIG. 4, Stage Notification 410 is presented illustrating that the General Information stage has been completed 412 and that the user is at the Configuration Planning stage 414. A Preview Stage 416 follows the Configuration Planning Stage 414.

A Parameter Explorer Window 420 is displayed. The Parameter Explorer Window 420 includes a Search Window 422 for searching for parameters to edit. A list of parameters 423 is shown in Parameter Explorer Window 420. The user is able to scroll down to other parameters using the Scroll Bar 424 in response to additional parameters being displayed lower in the Parameter Explorer Window 420. In Parameter Explorer Window 420, parameter ABPerPlmnList 426 is shown as being selected at Radio Button 428.

In FIG. 4, 4 parameters associated with ABPerPlmnList 426 are displayed in Parameter Window 440. For the parameters displayed in Parameter Window 440, a Parameter Name 442 is displayed, whether the parameter is Mandatory 444, an Action Owner 446, and an XPath 448 identifying where data for the parameter is located. In FIG. 4, parameter abcBarringSpecialAC 450 is selected and highlighted. The user clicks on Edit icon 460 to begin entering values for parameter abcBarringSpecialAC 450.

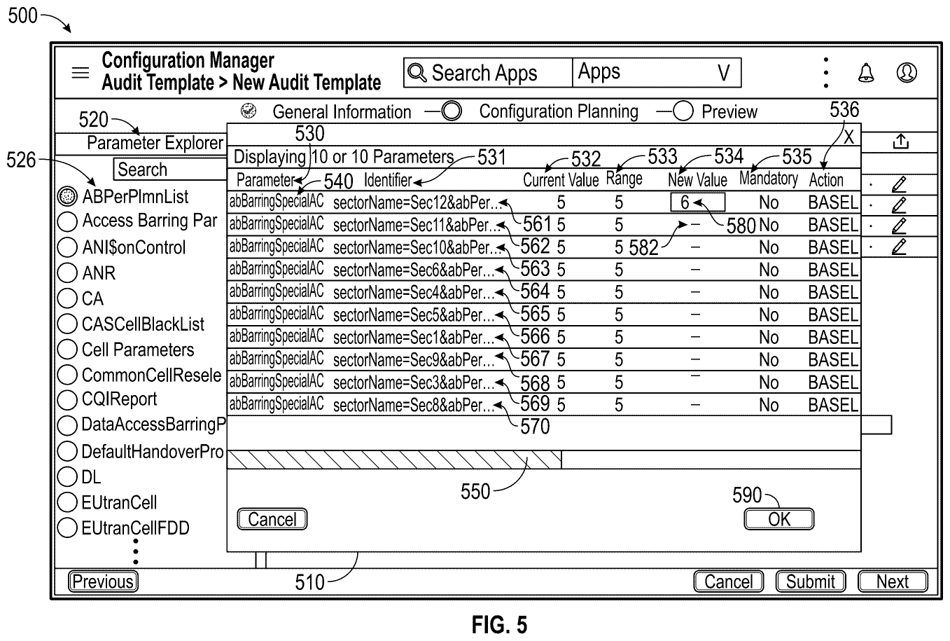

FIG. 5 illustrates a Set Parameter Value Page 500 according to at least one embodiment.

In FIG. 5, the Set Parameter Value Page 500 is displayed after the user clicks on the Edit icon 460 in FIG. 4. The Set Parameter Value Page 500 is displayed over the Select Parameter Page 400 as shown in FIG. 4. Set Parameter Value Page 500 shows a List of Parameters 510 associated with abBarringSpecialAC 526 as shown in the Parameter Explorer Window 520. List of Parameters 510 shows listings associated with Parameter Name 530 of abBarringSpecialAC 540.

List of Parameters 510 also includes an Identifier 531, Current Value 532, Range 533, New Value 534, Mandatory 535, and Action Owner 536. The remaining columns are not shown, but the user is able to use Scroll Bar 550 to cause the remaining columns to be displayed.

In FIG. 5, the Parameter Name 520 of abBarringSpecialAC 530 is shown for the different Identifiers 531, e.g., sectorName=12&abPer . . . 561, sectorName=11&abPer . . . 562, sectorName=10&abPer . . . 563, sectorName=6&abPer . . . 564, sectorName=4&abPer . . . 565, sectorName=5&abPer . . . 566, sectorName=1&abPer . . . 567, sectorName=9&abPer . . . 568, sectorName=3&abPer . . . 569, and sectorName=8&abPer . . . 570.

To set a new value for Parameter Name 530 of abBarringSpecialAC 540, the user clicks the area under New Value 534 that is aligned with abBarringSpecialAC 540. In FIG. 5, the user has clicked the area under New Value 534 that is aligned with abBarringSpecialAC 540 to cause New Value Window 580 to be displayed. Prior to New Value Window 580 being displayed, the area under New Value 534 that is aligned with abBarringSpecialAC 540 does not show a value as illustrated by the “dash” 582 in the next row. In List of Parameters 510, the user has entered the value of “6” in the New Value Window 580. The user then clicks the OK button 590 to return to the Select Parameter Page 400 as shown in FIG. 4.

Referring again to the Select Parameter Page 400 in FIG. 4, the Stage Notification 410 is updated. After being returned to the Select Parameter Page 400 in FIG. 4, Stage Notification 410 illustrates that the General Information stage 412 and the Configuration Planning stage 414 have been completed (not shown in FIG. 4. The Stage Notification 410 also illustrates that the user is now at the Preview stage 416. Once the user has completed selecting parameters from the Select Parameter Page 400, the user selects Next button 470 to continue.

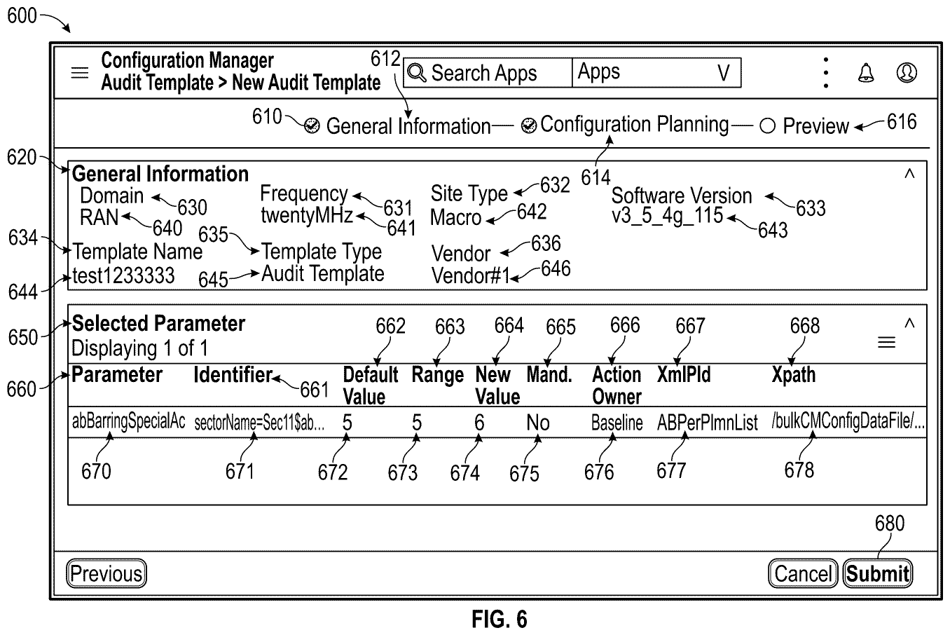

FIG. 6 illustrates a Preview Page 600 according to at least one embodiment.

Preview Page 600 is displayed in response to the user selecting the Next button 592 in FIG. 5. The Preview Page 600 includes a Stage Notification 610 illustrating that the General Information stage 612 and the Configuration Planning stage 614 have been completed. The Stage Notification 610 shows that the user is now at the Preview stage 616.

In FIG. 6, a General Information Area 620 is shown. General Information Area 620 shows the Domain 630 being RAN 640, the Frequency 631 being twentyMHz 641, the Site Type 632 being Macro 642, the Software Version 633 being v3_5_4g_115 643, the Template Name 634 being test1233333 644, the Template Type 635 being Audit Template 645, and the Vendor 636 being Vendor#1 646.

A Selected Parameter Area 650 is shown below the General Information Area 620. The Selected Parameter Area 650 includes a Parameter Name label 660, an Identifier label 661, a Default Value label 662, a Range label 663, a New Value label 664, a Mandatory label 665, an Action Owner label 666, an XmlPld label 667, and an XPath label 668.

The Parameter Name 660 is shown as being abBarringSpecialAC 670. The Identifier 661 is sectorName=Sec11$ab . . . 671. The Default Value 662 is “5” 672. The Range 663 is “5” 673.

The New Value 664 is shown as being “6” 674 as changed was illustrated in FIG. 5. Thus, the user is able to confirm that the New Value 664 for Parameter Name 660 of abBarringSpecialAC 670 has indeed changed to “6” 674.

The Mandatory value 665 is shown as being NO 675. The Action Owner 666 is Baseline 676. The XmlPld 667 is ABPerPlmnLIst 677. The XPath 668 is /bukCMConfigDataFile/ . . . 678. The user clicks on the Submit button 680 to complete the creation of the audit template.

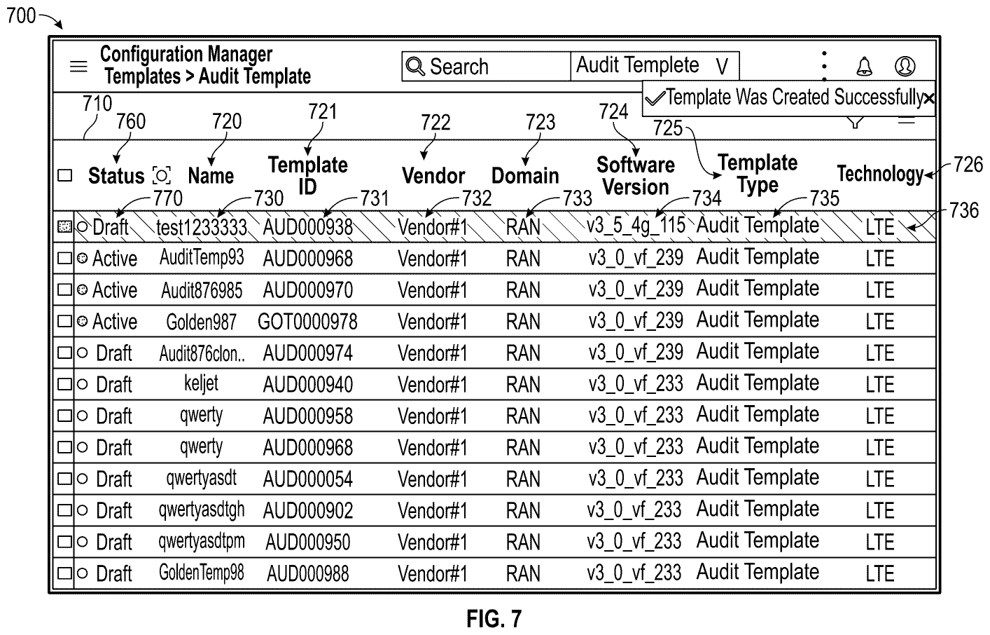

FIG. 7 illustrates the Audit Template Landing Page 700 according to at least one embodiment.

Again, Audit Template Landing Page 700 displays a List Of Custom Audit Templates 710. However, List Of Custom Audit Templates 710 now includes a listing of the new audit template having Template Name 720 of test1233333 730 and Template ID 721 of AUD000938 731. The Vendor Name 722 is show as being Vendor#1 732, the Doman 723 is shown as being RAN 733, the Software Version 724 is shown as being v3_5_4g_115 734, the Template Type 725 is shown as being Audit Template 735, and the Technology 726 is shown as being LTE 736.

FIG. 7 shows a notification that the Template Was Created Successfully 750. The Status 760 of audit template having Template Name 720 of test1233333 730 and Template ID 721 of AUD000938 731 is shown as being in Draft mode 770.

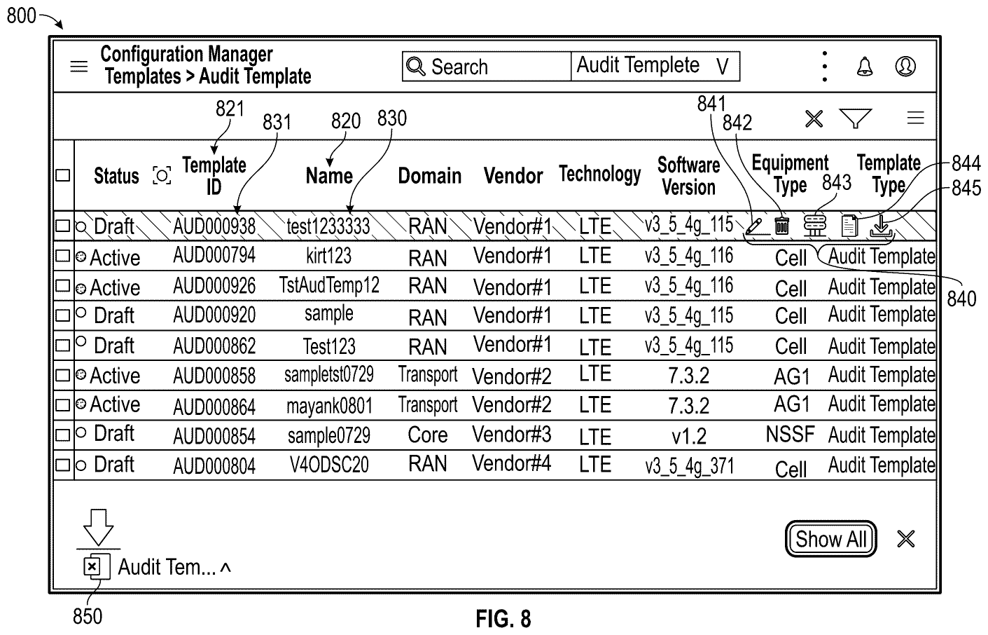

FIG. 8 illustrates options available from Audit Template Landing Page 800 according to at least one embodiment.

FIG. 8 shows that the audit template having Template Name 820 of test1233333 830 and Template ID 821 of AUD000938 831 is selected in the Audit Template Landing Page 800. Once the audit template having Template Name 820 of test1233333 830 is selected, options 840 are displayed. Options 840 include an Edit icon 841, a Delete icon 842, an Associate icon 843, a Details icon 844, and a Download icon 845.

In FIG. 8, the Edit icon 841 enables a user to edit audit template having Template Name 820 of test1233333 830. For example, upon selecting Edit icon 841, the user is taken to Basic Detail Entry Page 300 of FIG. 3, where the user is able to again change values. The process continues as described above with respect to FIGS. 3-7.

Instead of editing an audit template, the user is able to select the Delete icon 842. Selecting the Delete icon 842, in response to selecting audit template having Template Name 820 of test1233333 830, audit template having Template Name 820 of test1233333 830 is deleted.

The user selects the Details icon 844 to discover details about a selected audit template. The user selects the Download icon 845 to download the audit template. As shown in FIG. 8, an Excel File 850 of the Audit Template is being downloaded.

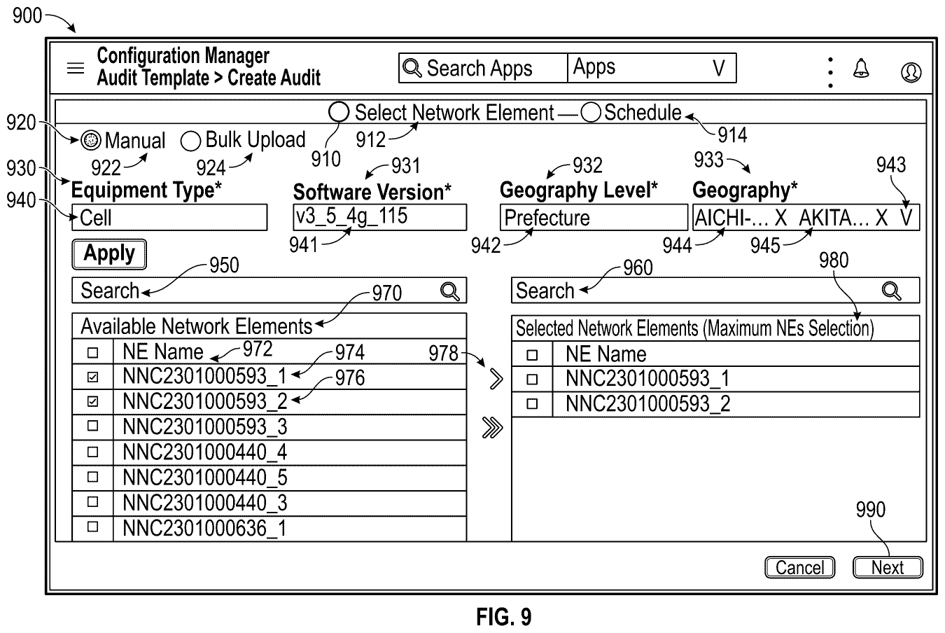

The user is able to select the Associate icon 843 to associate a NW element with the audit template. Once the user selects the Associate icon 843, a Select Network Element page 900 is displayed as shown in FIG. 9.

FIG. 9 illustrates a Select Network Element (NE) page 900 according to at least one embodiment.

In FIG. 9, a Stage Notification 910 is shown with the Select Network Element stage 912 being active. A Schedule stage 914 is shown after the Select Network Element stage 912. In FIG. 9, Radio Button 920 is shown selected indicating that Manual 922 has been selected. The user is also able to select Bulk Upload 924.

An Equipment Type Window 930 shows Cell 940 being entered. Software Version Window 931 shows the software version being v3_5_4g_115 941. A Geography Level Window 932 shows Prefecture 942. the Geography Window 933 includes a Drop-Down Selector 943 that allows a user to make geography selections in Geography Window 933. Here, Geography Window 933 shows the Aichi Prefecture 944 and Akita Prefecture 945 being selected.

A First Search Window 950 is provided for searching Available Network Elements 970. A Second Search Window 960 is shown for searching for Selected Network Elements 980.

The list of Available Network Elements 970 is presented for selection. In FIG. 9, the Available Network Elements 970 are identified by NE Name 972. Available Network Elements 970 having NE Names 972 of NN2301000593_1 974 and NN2301000593_2 976 are shown as being selected. The user is able to click on Arrow 978 to move NN2301000593_1 974 and NN2301000593_2 976 to the Selected Network Elements List 980. The user is then able to select the Next button 990 to move to the Schedule stage 914.

FIG. 10 illustrates a Scheduling Window 1000 according to at least one embodiment.

In FIG. 10, a Stage Notification 1010 is shown with the Select Network Element stage 1012 being completed and the Schedule stage 1014 being active.

A Template Information Area 1020 is shown under the Stage Notification 1010. Template Information Area 1020 displays the Name 1030 for the audit template as test1233333 1040. The Domain 1031 is identified as RAN 1041. The Device Type 1032 is Cell 1042, the Vendor Name 1033 is Vendor#1 1043, the Technology 1034 is LTE 1044, the Band 1035 is twentyMHz 1045, and the Audit Type 1036 is Audit Template 1046.

A Network Element Area 1050 lists information about the selected network elements. The Network Element Area 1050 identifies 2 Network Elements 1060, NN2301000593_1 1070 and NN2301000593_2 1080. For NN2301000593_1 1070, the Domain 1061 is RAN 1071, the Vendor Name 1062 is Vendor#1 1072, the Technology 1063 is LTE 1073, the Network Type 1064 is Macro Cell 1074, and the Software Version 1065 is v3_5_4g_115 1075. For NN2301000593_2 1080, the Domain 1061 is RAN 1081, the Vendor Name 1062 is Vendor#1 1082, the Technology 1063 is LTE 1083, the Network Type 1064 is Macro Cell 1084, and the Software Version 1065 is v3_5_4g_115 1085.

Schedule Area 1090 enables a user to enter scheduling parameters for performing the audit based on the audit template. In FIG. 10, Schedule Area 1090 includes a Frequency Time Window 1091. Frequency Time Window 1091 show the audit schedule for being performed daily at one time 1092. A Date Window 1093 allows a date or range of dates to be entered manually or using Calendar icon 1094. Time Window 1095 is provided for setting a time to perform the audit, which may be entered manually or by selecting on Clock icon 1096. Once the user has completed the schedule for the audit template, the user selects the Submit button 1097.

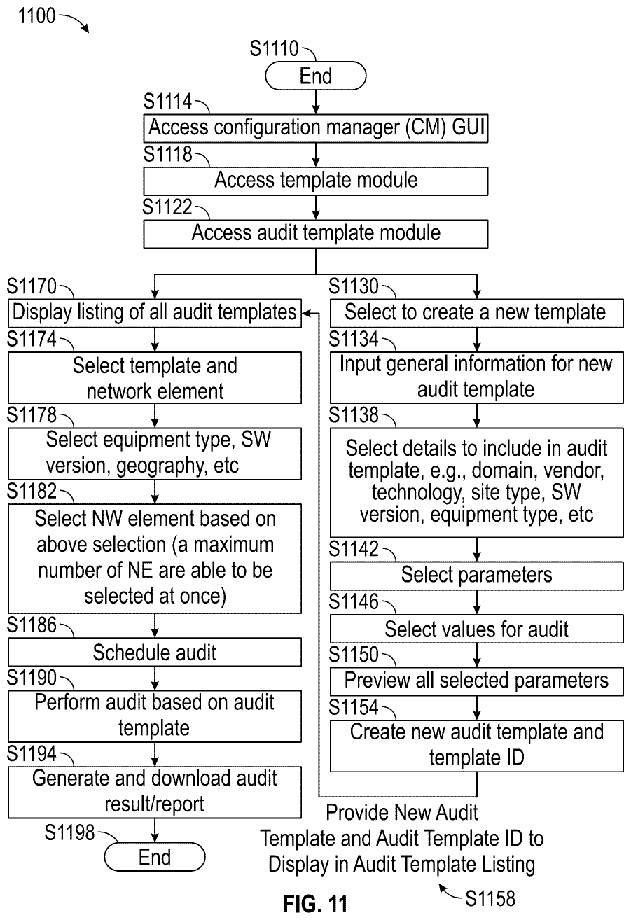

FIG. 11 is a flowchart 1100 of a method for providing customized audit templates according to at least one embodiment.

In FIG. 11, the process starts S1110 and the user accesses the Configuration Manager (CM) UI S1114.

From the CM UI, the user accesses a template system S1118. There are different template modules including templates that do not relate to audits.

Under the template system is an audit template system that the user accesses S1122. The audit template system takes the user to a landing page, where the user decides to select a pre-existing temple, to edit a pre-existing audit template, or to create a new audit template for auditing particular equipment where the data is populated into a report. Referring to FIG. 2, Audit Template Landing Page 200 is displayed in response to the user accessing the audit template system. Audit Template Landing Page 200 is shown as being under the Audit Template system 202, which is a subset of Templates 204. The Audit Template Landing Page 200 is presented from the Configuration Manager UI 206. Through use of the Audit Template Landing Page 200, the user is able to select a pre-existing temple 210 or select pre-existing audit template 210 to edit by clicking in the Check Box 208. The user is also able to select to create a new audit template for auditing particular equipment and parameters of network elements. The Listing Of Audit Templates 210 presents Audit Template Status 212, Template ID 214, Template Name 216, Domain 218, Vendor Name 220, Technology associated with the Audit Template 222, Software Version 224, Equipment Type 226 and Template Type 228. A Search Window 230 is provided for the user to perform a search for an audit template. A drop-down menu 232 enables the user to select what type of template the user is searching for in the Search Window 230. FIG. 2 illustrates that Audit Template has been selected in the drop-down menu 232, which is associated with a search for an audit template. To create an audit template from the Audit Template Landing Page 200, the user selects the “add/+” icon 214.

In response to the user deciding to create a new audit template, the user initiates creation of a new audit template from the landing page S1130. Referring to FIG. 2, to create an audit template from the Audit Template Landing Page 200, the user selects the “add/+” icon 214.

After initiating the creation of a new template, the user provides some general information, e.g., basic information S1134. Referring to FIG. 3, the Basic Detail Entry Page 300 is displayed in response to selecting the “add/+” icon 214 in FIG. 2. The user is guided by the Basic Data Entry Page 300 to input specific information. Thus, the user does not manually enter data. The user is given the visibility to select input via the windows, which in some cases provide drop-down menus for entering information.

After entering the basic information, technical details are entered S1138. The technical details include information such information about the domain, the vendor, the technology, the site type, the software version, equipment type, etc. Referring to FIG. 3, a Select Template Area 320 is shown under the Stage Notification 310. Select Template Area 320 includes a Domain Window 322 where Transport 323 has been selected. Transport 323 is one type of domain the user is able to select from Drop-Down Menu 324. Other choices include RAN (Radio Access Network) and Core (i.e., Core Network). Vendor Window 326 is for entry of the name of the vendor. Technology Window 328 is used to define the type of technology associated with the audit template. A Template Type Window 330 is used to define the type of template being created. Here, an Audit Template 332 is selected. A Basic Details Area 330 is used to enter basic information about the audit template being created. Basic Details Area 330 includes a Template Name Window for naming the audit template being created. For example, test123333 is a name that is able to be given to a new audit template. A Site Type Window 340 is used to identify the type of cell, e.g., macro cell, micro cell, femto cell, etc. A Software Version Window 342 is used to identify the version of the software, e.g., v3_5_4g_115. A Frequency Window 344 is used to identify the channel bandwidth, e.g., 20 MHz, 40 MHz, etc. An Equipment Type Window 346 is used to identify the type of equipment associated with the audit template, such as Cell, Aggregate Router (AG), NSSP (Network Slice Selection Policy), NRF (Network Repository Function). A Group Window 348 is used to identify a test group, e.g., test21e2i. After the user has completed entry of the data in Basic Detail Entry Page 300, the user selects the Submit button to begin entering parameter data.

Then user selects the parameters for the audit template S1142. Referring to FIG. 4, a Parameter Explorer Window 420 is displayed. The Parameter Explorer Window 420 includes a Search Window 422 for searching for parameters to edit. A list of parameters is shown in Parameter Explorer Window 420. The user is able to scroll down to other parameters using the Scroll Bar 424 in response to additional parameters being displayed lower in the Parameter Explorer Window 420. In Parameter Explorer Window 420, parameter ABPerPlmnList 426 is shown as being selected at Radio Button 428. In FIG. 4, 4 parameters associated with ABPerPlmnList 426 are displayed in Parameter Window 440. For the parameters displayed in Parameter Window 440, a Parameter Name 442 is displayed, whether the parameter is Mandatory 444, an Action Owner 446, and an XPath 448 identifying where data for the parameter is located. In FIG. 4, parameter abcBarringSpecialAC 450 is selected and highlighted. The user clicks on Edit icon 460 to begin entering values for parameter abcBarringSpecialAC 450.

The user then selects values for the parameters S1146. For example, a particular range or particular value for a parameter is selected. Referring to FIG. 5, the Set Parameter Value Page 500 is displayed after the user clicks on the Edit icon 460 in FIG. 4. The Set Parameter Value Page 500 is displayed over the Select Parameter Page 400 shown in FIG. 4. Set Parameter Value Page 500 shows a List of Parameters 510 associated with abBarringSpecialAC 526 as shown in the Parameter Explorer Window 520. List of Parameters 510 shows listings associated with Parameter Name 530 of abBarringSpecialAC 540. List of Parameters 510 also includes an Identifier 531, Current Value 532, Range 533, New Value 534, Mandatory 535, and Action Owner 536. The remaining columns are not shown, but the user is able to use Scroll Bar 550 to cause the remaining columns to be displayed. To set a new value for Parameter Name 530 of abBarringSpecialAC 540, the user clicks the area under New Value 534 that is aligned with abBarringSpecialAC 540. In FIG. 5, the user has clicked the area under New Value 534 that is aligned with abBarringSpecialAC 540 to cause New Value Window 580 to be displayed. Prior to New Value Window 580 being displayed, the area under New Value 534 that is aligned with abBarringSpecialAC 540 does not show a value as illustrated by the “dash” 582 in the next row. In List of Parameters 510, the user has entered the value of “6” in the New Value Window 580. The user then clicks the OK button 590 to return to the Select Parameter Page 400 as shown in FIG. 4.

The user previews the selected parameters before scheduling or before creating the template S1150. Previewing the selected parameters allows the user to determine whether the selection of the parameters of values indicate a change is to be made. Referring to FIG. 6, Preview Page 600 is displayed in response to the user selecting the Next button 470 in FIG. 4. The Preview Page 600 includes a Stage Notification 610 illustrating that the General Information stage 612 and the Configuration Planning stage 614 have been completed. The Stage Notification 610 shows that the user is now at the Preview stage 616. In FIG. 6, a General Information Area 620 is shown. General Information Area 620 shows the Domain 630 being RAN 640, the Frequency 631 being twentyMHz 641, the Site Type 632 being Macro 642, the Software Version 633 being v3_5_4g_115 643, the Template Name 634 being test1233333 644, the Template Type 635 being Audit Template 645, and the Vendor 636 being Vendor#1 646. A Selected Parameter Area 650 is shown below the General Information Area 620. The Selected Parameter Area 650 includes a Parameter Name label 660, an Identifier label 661, a Default Value label 662, a Range label 663, a New Value label 664, a Mandatory label 665, an Action Owner label 666, an XmlPld label 667, and an XPath label. The user clicks on the Submit button 680 to complete the creation of the audit template.

Once the user is satisfied with the preview, the user is able to submit the audit template for creation and a new audit template identifier (ID) is associated with the created audit template S1154. Referring to FIG. 7, the status of audit template having Template Name 720 of test1233333 730 and Template ID 721 of AUD000938 731 is shown as being in Draft mode 770.

The new audit template and associated audit template ID is provided for presentation of the audit template listing S1158. Referring to FIG. 8, the audit template having Template Name 820 of test1233333 830 and Template ID 1021 of AUD000938 831 is selected in the Audit Template Landing Page 800. Once the audit template having Template Name 820 of test1233333 830 is selected, options 840 are displayed. Options 840 include an Edit icon 841, a Delete icon 842, an Associate icon 843, a Details icon 844, and a Download icon 845.

The user is presented the template listing and the user is able to select an audit template from the listing S1170. In response to the user deciding to not create a new audit template, the user is presented the template listing and, from here, the user is able to select a pre-existing temple, to edit a pre-existing audit template. Existing audit templates are created by other users or are templates previously created by the user.

The user selects a network element for auditing S1174. Referring to FIG. 8, the user is able to select the Associate icon 843 to associate a NW element with the audit template. Once the user selects the Associate icon 843, a Select Network Element page 900 is displayed as shown in FIG. 9.

The user selects the equipment type, the software version, and geography, such as city, prefecture, and other information S1178. Referring to FIG. 9, an Equipment Type Window 930 shows Cell 940 being entered. Software Version Window 931 shows the software version being v3_5_4g_115 941. A Geography Level Window 932 shows Prefecture 942. the Geography Window 933 includes a Drop-Down Selector 943 that allows a user to make geography selections in Geography Window 933. Here, Geography Window 933 shows the Aichi and Akita Prefectures being selected. A First Search Window 950 is provided for searching available Network Elements. A Second Search Window 960 is shown for searching for Selected Network Elements. A list of Available Network Elements 970 is presented for selection. In FIG. 9, the Available Network Elements 952 are identified by NE Name 972. Available Network Elements 970 having NE Names 972 of NN2301000593_1 974 and NN2301000593_2 976 are shown as being selected. The user is able to click on Arrow 978 to move NN2301000593_1 974 and NN2301000593_2 976 to the Selected Network Elements List 980. The user is then able to select the Next button 990 to move to the Schedule stage 914.

The network element is selected based on the above information S1182.

The user enters a schedule for the audit to be perform based on the audit template S1186. The user is able to select a daily, monthly, bi-weekly, two times per day, or three times per day audit report. Referring to FIG. 10, Schedule Area 1090 enables a user to enter scheduling parameters for performing the audit based on the audit template. In FIG. 10, Schedule Area 1090 includes a Frequency Time Window 1091. Frequency Time Window 1091 show the audit schedule for being performed daily at one time 1092. A Date Window 1093 allows a date or range of dates to be entered manually or using Calendar icon 1094. Time Window 1095 is provided for setting a time to perform the audit, which may be entered manually or by selecting on Clock icon 1096. Once the user has completed the schedule for the audit template, the user selects the Submit button 1097.

The audit is performed based on the audit template according to the schedule S1190. Referring to FIG. 1, NMS 170 performs the audit according to the scheduled time to collect performance data of network elements.

After the audit is performed, results or a report of audit values is generated and downloaded by the user S1194. The audit results are populated and a report is generated for the user to review. For example, in at least one embodiment, data is presented in an Excel format.

The process then ends S1198.

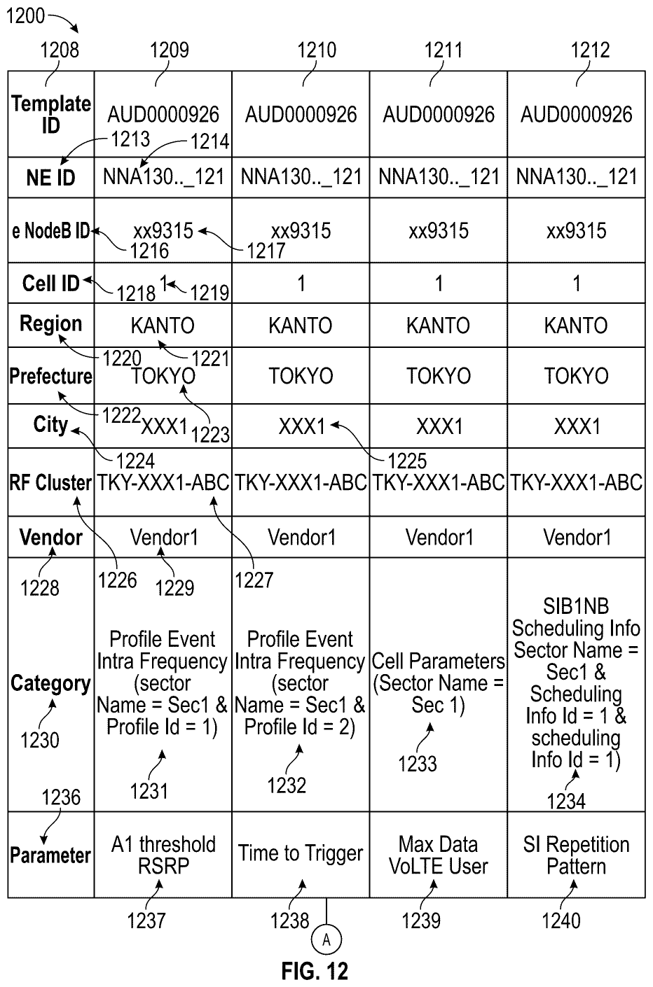

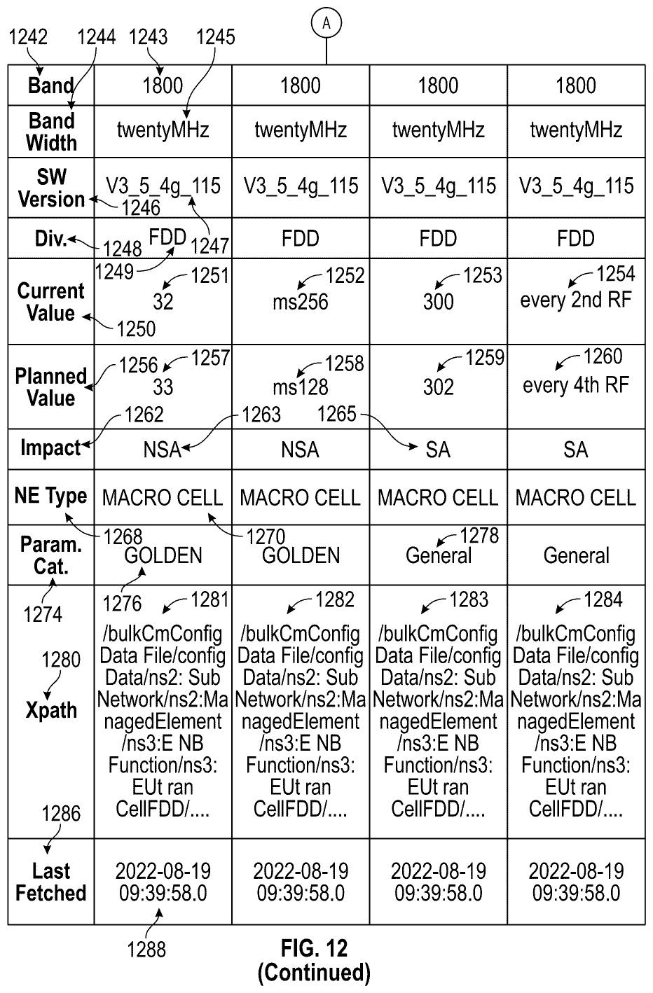

FIG. 12 illustrates an example of an audit report 1200 based on a customized audit template according to at least one embodiment.

In FIG. 12, four Template IDs 1208 are shown, which include AUD0000926 1209, AUD0000926 1212, AUD0000926 1213, and AUD0000926 1214. In FIG. 12, the Template IDs 1208 are the same. However, in at least one embodiment, the Template IDs 1208 are different.

The Network Element ID 1213 for the four Template IDs 1209, 1212, 1213, 1214 is NNA130 . . . _121 1214. The eNodeB ID 1216 for the four Template IDs 1209, 1212, 1213, 1214 is xx9315 1217, and the Cell ID 1218 for the four Template IDs 1209, 1212, 1213, 1214 is 1 1219.

For the four Template IDS 1209, 1212, 1213, 1214 have a Region 1220 of Kanto 1221, a Prefecture 1222 of Tokyo 1223, and a City 1224 of XXX1 1225. The four Template IDs 1209, 1212, 1213, 1214 have an RF Cluster 1226 of TKY-XXX1_ABC 1227 and a Vendor Name 1228 of Vendor#1 1229.

The Category 1230 associated with Template ID 1209 is Profile Event Intra Frequency (sector Name=Sec1&profileID=1) 1231. The Category 1230 associated with Template ID 1210 is Profile Event Intra Frequency (sector Name=Sec1&profileID=1) 1232. The Category 1230 associated with Template ID 1211 is Cell Parameters (sectorName=Sec1) 1233, and the Category 1230 associated with Template ID 1212 is SIB1NB Scheduling Info (sectorName=Sect1&schedulingInfoID=1&schedulingInfoID=1) 1234.

The Parameter 1236 associated with Template ID 1209 is A1 threshold RSRP 1237. The Parameter 1236 associated with Template ID 1210 is Time To Trigger 1238. The Parameter 1236 associated with Template ID 1211 is Max Data VOLTE User 1239. The Parameter 1236 associated with Template ID 1212 is SI Repetition 1240. The Band 1242 for Template IDs 1209, 1210, 1211, 1212 is 1800 1243. The Bandwidth 1244 for Template IDs 1209, 1210, 1211, 1212 is twentyMHz (20 MHZ) 1245. The Software Version 1246 for Template IDs 1209, 1210, 1211, 1212 is v3_5_4g_115 1247.

The Transmission Scheme 1248 for Template IDs 1209, 1210, 1211, 1212 is Frequency Division Duplexing (FDD) 1249. The Current Values 1250 for Template IDs 1209, 1210, 1211, 1212 are 32 1251, ms256 1252, 300 1253, and every 2nd RF 1254, respectively. The Planned Values 1256 for Template IDs 1209, 1210, 1211, 1212 are 33 1257, ms128 1258, 302 1259, and every 4th RF 1260, respectively.

The Impact 1262 for Template IDs 1209, 1210 is Non-Standalone (NSA) 1263. The Impact 1262 for Template IDs 1209, 1210 is Standalone (SA) 1265. The NE Type 1268 for Template IDs 1209, 1210, 1211, 1212 is Macro Cell 1270. The Parameter Category 1274 for Template IDs 1209, 1210 is Golden 1276. The Parameter Category 1274 for Template IDs 1211, 1212 is General 1278.

The XPaths 1280 for the four Template IDs 1209, 1210, 1211, 1212 are /bulkCmConfigDataFile/configData/ . . . /ioc:a1InterSonA1ThresholdRsrp 1281, /bulkCmConfigDataFile/configData/ . . . /ioc:a3InterTimeToTrigger 1282, /bulkCmConfigDataFile/ . . . /ioc:maxVolteUsers 1283, and /bulkCmConfigDataFile/ . . . /ioc:siRepetitionPattern 1284, respectively. The Last Fetched Times 1286 for the four Template IDs 1209, 1210, 1211, 1212 is 2022-08-19 09:39:58.0 1288.

At least one embodiment of providing customized audit templates includes displaying a list of custom audit templates on an audit template user interface (UI) presented on a display device, from the audit template UI, receiving a selection to perform an action selected from: using a pre-existing audit template selected from the list of custom audit templates, editing the pre-existing audit template selected from the list of custom audit templates, or creating a new audit template to present in the list of custom audit templates, based on the selection, identifying one audit template from the list of custom audit templates to use to perform the audit on at least one network element, executing the audit to collect performance data of the at least one network element based on the one audit template identified from the list of custom audit templates, and generating a report using results obtained from executing the audit based on the one audit template identified from the list of custom audit templates.

Advantages include being able to perform an audit using an audit template that is created by the user for auditing parameters of interest to the user and based on user selection. The time of the audit is selectable as well as the network element. Audit templates are created for a customized list of parameters, e.g., individual parameters, a set of parameters, or all parameters. The customized audit templates enable audits for a single network element or multiple network elements. Currently, this type of customization is not available.

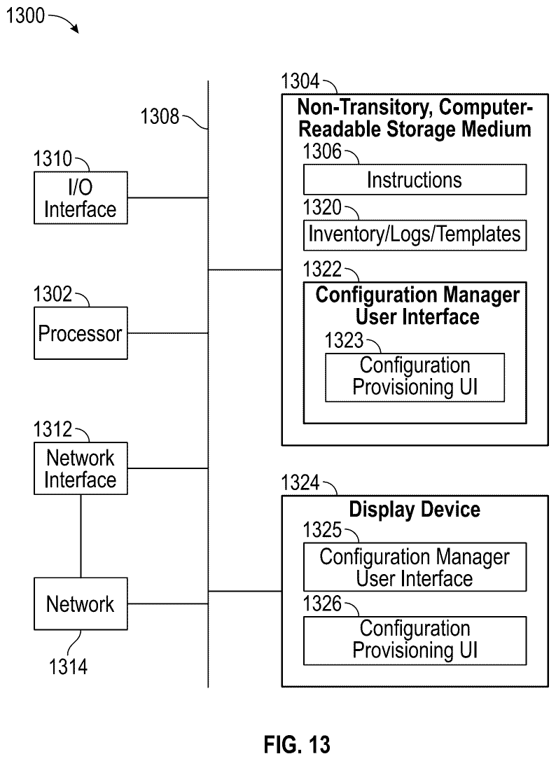

FIG. 13 is a high-level functional block diagram of a processor-based system 1300 according to at least one embodiment.

In at least one embodiment, processing circuitry 1300 provides customized audit templates. Processing circuitry 1300 implements customized audit templates using processor 1302. Processing circuitry 1300 also includes a non-transitory, computer-readable storage medium 1304 that is used to implement customized audit templates. Storage medium 1304, amongst other things, is encoded with, i.e., stores, instructions 1306, i.e., computer program code that are executed by processor 1302 causes processor 1302 to perform operations for providing customized audit templates. Execution of instructions 1306 by processor 1302 implements at least a portion of the methods described herein in accordance with one or more embodiments (hereinafter, the noted processes and/or methods).

Processor 1302 is electrically coupled to computer-readable storage medium 1304 via a bus 1308. Processor 1302 is electrically coupled to an Input/output (I/O) interface 1310 by bus 1308. A network interface 1312 is also electrically connected to processor 1302 via bus 1308. Network interface 1312 is connected to a network 1314, so that processor 1302 and computer-readable storage medium 1304 connect to external elements via network 1314. Processor 1302 is configured to execute instructions 1306 encoded in computer-readable storage medium 1304 to cause processing circuitry 1300 to be usable for performing at least a portion of the processes and/or methods. In one or more embodiments, processor 1302 is a Central Processing Unit (CPU), a multi-processor, a distributed processing system, an Application Specific Integrated Circuit (ASIC), and/or a suitable processing unit.

Processing circuitry 1300 includes I/O interface 1310. I/O interface 1310 is coupled to external circuitry. In one or more embodiments, I/O interface 1310 includes a keyboard, keypad, mouse, trackball, trackpad, touchscreen, and/or cursor direction keys for communicating information and commands to processor 1302.

Processing circuitry 1300 also includes network interface 1312 coupled to processor 1302. Network interface 1312 allows processing circuitry 1300 to communicate with network 1314, to which one or more other computer systems are connected. Network interface 1312 includes wireless network interfaces such as Bluetooth, Wi-Fi, Worldwide Interoperability for Microwave Access (WiMAX), General Packet Radio Service (GPRS), or Wideband Code Division Multiple Access (WCDMA); or wired network interfaces such as Ethernet, Universal Serial Bus (USB), or Institute of Electrical and Electronics Engineers (IEEE) 1364.

Processing circuitry 1300 is configured to receive information through I/O interface 1310. The information received through I/O interface 1310 includes one or more of instructions, data, design rules, libraries of cells, and/or other parameters for processing by processor 1302. The information is transferred to processor 1302 via bus 1308. Processor 1302 is configured to receive information related to a Configuration Manager (CM) User Interface (UI) 1322 through I/O interface 1310. Processor 1302 is configured to receive information related to a Configuration Provisioning UI 1323 that is used to create audit templates. The information is stored in computer-readable medium 1304 as CM UI 1322 and Configuration Provisioning UI 1323.

Processor 1302 causes Display Device 1324 to display the CM UI 1325 and Configuration Provisioning UI 1326. In at least one embodiment, a user uses Configuration Provisioning UI 1326 to create customizable audit templates used to audit the parameters of network elements. From Configuration Provisioning UI 1326, the user is able to select a pre-existing temple, edit a pre-existing audit template, or create a new audit template for auditing particular equipment where the data is populated into a report. By using customizable audit templates, a user is provided more flexibility and control over what data to collect. In at least one embodiment, a user uses Configuration Provisioning UI 1326 to select one or more network elements, and select parameters of interest associated with the one or more network elements. In response to a user wanting to audit, for example, core elements, the user creates a template that is customized for auditing the data the user is interested in reviewing. Audit templates are created or edited to audit the parameters the user is interested in reviewing.

A user is able create the customized audit template and perform an audit using the customized audit template that focuses on parameters of interest to the user and are based on user selection. The user is able to use Configuration Provisioning UI 1326 to select the time of the audit as well as the network element. Configuration Provisioning UI 1326 is used to create audit templates for a customized list of parameters, e.g., individual parameters, a set of parameters, or all parameters. The customized audit templates enable audits for a single network element or multiple network elements.

In one or more embodiments, one or more non-transitory computer-readable storage media 1304 having stored thereon instructions (in compressed or uncompressed form) that may be used to program a computer, processor, or other electronic device) to perform processes or methods described herein. The one or more non-transitory computer-readable storage media 1304 include one or more of an electronic storage medium, a magnetic storage medium, an optical storage medium, a quantum storage medium, or the like. For example, the computer-readable storage media may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. In one or more embodiments using optical disks, the one or more non-transitory computer-readable storage media 1304 includes a Compact Disk-Read Only Memory (CD-ROM), a Compact Disk-Read/Write (CD-R/W), and/or a Digital Video Disc (DVD).

In one or more embodiments, storage medium 1304 stores computer program code 1306 configured to cause processing circuitry 1300 to perform at least a portion of the processes and/or methods for providing customized audit templates. In one or more embodiments, storage medium 1304 also stores information, such as algorithm which facilitates performing at least a portion of the processes and/or methods for providing customized audit templates. Accordingly, in at least one embodiment, the processor circuitry 1300 performs a method for providing customized audit templates. The method includes displaying a list of custom audit templates on an audit template user interface (UI) presented on a display device, from the audit template UI, receiving a selection to perform an action selected from: using a pre-existing audit template selected from the list of custom audit templates, editing the pre-existing audit template selected from the list of custom audit templates, or creating a new audit template to present in the list of custom audit templates, based on the selection, identifying one audit template from the list of custom audit templates to use to perform the audit on at least one network element, executing the audit to collect performance data of the at least one network element based on the one audit template identified from the list of custom audit templates, and generating a report using results obtained from executing the audit based on the one audit template identified from the list of custom audit templates.

The process for providing customized audit parameters enables a user to perform an audit using an audit template that is created by the user for auditing parameters of interest to the user and based on user selection. The time of the audit is selectable as well as the network element. Audit templates are created for a customized list of parameters, e.g., individual parameters, a set of parameters, or all parameters. The customized audit templates enable audits for a single network element or multiple network elements. Currently, this type of customization is not available.

Separate instances of these programs can be executed on or distributed across any number of separate computer systems. Thus, although certain steps have been described as being performed by certain devices, software programs, processes, or entities, this need not be the case. A variety of alternative implementations will be understood by those having ordinary skill in the art.

Additionally, those having ordinary skill in the art readily recognize that the techniques described above can be utilized in a variety of devices, environments, and situations. Although the embodiments have been described in language specific to structural features or methodological acts, the subject matter defined in the appended claims is not necessarily limited to the specific features or acts described. Rather, the specific features and acts are disclosed as exemplary forms of implementing the claims.

1. A method for providing customized audit templates, comprising:
displaying a list of custom audit templates on an audit template user interface (UI) presented on a display device;
from the audit template UI, receiving a selection to perform an action selected from: using a pre-existing audit template selected from the list of custom audit templates, editing the pre-existing audit template selected from the list of custom audit templates, or creating a new audit template to present in the list of custom audit templates;
based on the selection, identifying one audit template from the list of custom audit templates to use to perform the audit on at least one network element;
executing the audit to collect performance data of the at least one network element based on the one audit template identified from the list of custom audit templates audit templates; and
generating a report using results obtained from executing the audit based on the one audit template identified from the list of custom audit templates audit templates.

2. The method of claim 1 further comprising:
in response to receiving the selection to create the new audit template, presenting at least one data entry page for receiving information defining the new audit template;
defining the new audit template based on information receiving from the at least one data entry page; and
presenting the new audit template in the list of custom audit templates on the audit template UI.

3. The method of claim 2, wherein the defining the new audit template based on information entered from the at least one data entry page further includes presenting, on the audit template UI:
a basic details entry page for receiving general information associated with the new audit template;
a select parameter page for receiving at least one parameter associated with the new audit template; and
a set parameter value page for setting at least one value associated with the at least one parameter.

4. The method of claim 3 further comprising presenting, on the audit template UI, a preview page showing details defining the new audit template prior to presenting the new audit template in the list of custom audit templates on the audit template UI.

5. The method of claim 2, wherein:
the identifying the one audit template from the list of custom audit templates to use to perform the audit further includes identifying the new audit template to use to perform the audit; and
the executing the audit based on the one audit template identified from the list of custom audit templates further includes configuring the new audit template in the list of custom audit templates on the audit template UI, scheduling a time for the executing of the audit based on the new audit template, and executing the audit based on the new audit template at the time scheduled.

6. The method of claim 5, wherein the configuring the new audit template includes receiving a selection, from at least one configuration page presented in the audit template UI, a network element to associate with the new audit template, and receiving data defining the network element.

7. The method of claim 1, wherein:
the identifying one audit template from the list of custom audit templates to use to perform the audit includes identifying the pre-existing audit template in the list of custom audit templates on the audit template UI and configuring the pre-existing audit template to collect data on the at least one network element, and wherein the executing the audit template includes executing the pre-existing audit template; or
the identifying one audit template from the list of custom audit templates to use to perform the audit includes identifying the pre-existing audit template in the list of custom audit templates on the audit template UI to edit, and editing the pre-existing audit template identified in the list of custom audit templates on the audit template UI to generate an edited audit template to collect data on the at least one network element, and wherein the executing the audit template includes executing the edited audit template.

8. A device for providing customized audit templates, comprising:
a memory storing computer-readable instructions; and
a processor connected to the memory, wherein the processor is configured to execute the computer-readable instructions to:
display a list of custom audit templates on an audit template user interface (UI) presented on a display device;
from the audit template UI, receive a selection to perform an action selected from: using a pre-existing audit template selected from the list of custom audit templates, editing the pre-existing audit template selected from the list of custom audit templates, or creating a new audit template to present in the list of custom audit templates;
based on the selection, identifying one audit template from the list of custom audit templates to use to perform the audit on at least one network element;
executing the audit to collect performance data of the at least one network element based on the one audit template identified from the list of custom audit templates; and
generating a report using results obtained from executing the audit based on the one audit template identified from the list of custom audit templates.

9. The device of claim 8, wherein the processor is further configured to:
in response to receiving the selection to create the new audit template, present at least one data entry page for receiving information defining the new audit template;
define the new audit template based on information received from the at least one data entry page; and
present the new audit template in the list of custom audit templates on the audit template UI.

10. The device of claim 9, wherein the processor is configured to define the new audit template based on information entered from the at least one data entry page by presenting, on the audit template UI:
a basic details entry page for receiving general information associated with the new audit template;
a select parameter page for receiving at least one parameter associated with the new audit template; and
a set parameter value page for setting at least one value associated with the at least one parameter.

11. The device of claim 10, wherein the processor is further configured to present, on the audit template UI, a preview page showing details defining the new audit template prior to presenting the new audit template in the list of custom audit templates on the audit template UI.

12. The device of claim 9, wherein the processor is further configured to:
identify the one audit template from the list of custom audit templates to use to perform the audit by identifying the new audit template to use to perform the audit; and
execute the audit based on the one audit template identified from the list of custom audit templates by configuring the new audit template in the list of custom audit templates on the audit template UI, scheduling a time for the executing of the audit based on the new audit template, and executing the audit based on the new audit template at the time scheduled.

13. The device of claim 12, wherein the processor is further configured to configure the new audit template by receiving a selection, from at least one configuration page presented in the audit template UI, a network element to associate with the new audit template, and receiving data defining the network element.

14. The device of claim 8, wherein the processor is further configured:
to identify one audit template from the list of custom audit templates to use to perform the audit includes identifying the pre-existing audit template in the list of custom audit templates on the audit template UI and configuring the pre-existing audit template to collect data on the at least one network element, and wherein the executing the audit template includes executing the pre-existing audit template; or
to identify one audit template from the list of custom audit templates to use to perform the audit includes identifying the pre-existing audit template in the list of custom audit templates on the audit template UI to edit, and editing the pre-existing audit template identified in the list of custom audit templates on the audit template UI to generate an edited audit template to collect data on the at least one network element, and wherein the executing the audit template includes executing the edited audit template.

15. A non-transitory computer-readable media having computer-readable instructions stored thereon, which when executed by a processor causes the processor to perform operations comprising:
displaying a list of custom audit templates on an audit template user interface (UI) presented on a display device;
from the audit template UI, receiving a selection to perform an action selected from: using a pre-existing audit template selected from the list of custom audit templates, editing the pre-existing audit template selected from the list of custom audit templates, or creating a new audit template to present in the list of custom audit templates;
based on the selection, identifying one audit template from the list of custom audit templates to use to perform the audit of at least one network element;
executing the audit to collect performance data of the at least one network element based on the one audit template identified from the list of custom audit templates; and
generating a report using results obtained from executing the audit based on the one audit template identified from the list of custom audit templates.

16. The non-transitory computer-readable media of claim 15, further comprising:
in response to selecting to create the new audit template, presenting at least one data entry page for entering information defining the new audit template;
defining the new audit template based on information entered from the at least one data entry page; and
presenting the new audit template in the list of custom audit templates on the audit template UI.

17. The non-transitory computer-readable media of claim 16, wherein the defining the new audit template based on information entered from the at least one data entry page further includes presenting, on the audit template UI:
a basic details entry page for receiving general information associated with the new audit template;
a select parameter page for receiving at least one parameter associated with the new audit template; and
a set parameter value page for setting at least one value associated with the at least one parameter.

18. The non-transitory computer-readable media of claim 17 further comprising presenting, on the audit template UI, a preview page showing details defining the new audit template prior to presenting the new audit template in the list of custom audit templates on the audit template UI.

19. The non-transitory computer-readable media of claim 16, wherein:
the identifying the one audit template from the list of custom audit templates to use to perform the audit further includes identifying the new audit template to use to perform the audit;
the executing the audit based on the one audit template identified from the list of custom audit templates further includes configuring the new audit template in the list of custom audit templates on the audit template UI, scheduling a time for the executing of the audit based on the new audit template, and executing the audit based on the new audit template at the time scheduled; and
wherein the configuring the new audit template includes selecting, from at least one configuration page presented in the audit template UI, a network element to associate with the new audit template, and receiving data defining the network element.

20. The non-transitory computer-readable media of claim 15, wherein:
the identifying one audit template from the list of custom audit templates to use to perform the audit includes identifying the pre-existing audit template in the list of custom audit templates on the audit template UI and configuring the pre-existing audit template to collect data on the at least one network element, and wherein the executing the audit template includes executing the pre-existing audit template; or
the identifying one audit template from the list of custom audit templates to use to perform the audit includes identifying the pre-existing audit template in the list of custom audit templates on the audit template UI to edit, and editing the pre-existing audit template identified in the list of custom audit templates on the audit template UI to generate an edited audit template to collect data on the at least one network element, and wherein the executing the audit template includes executing the edited audit template.
